(19) United States
(12) Patent Application Publication
(10) Pub. No.: US 2024/0032723 A1
(43) Pub. Date: Feb. 1, 2024

(54) SYSTEM FOR DISPENSING INDIVIDUAL PORTIONS OF BEVERAGES PRECURSOR

(71) Applicant: SOCIETE DES PRODUITS NESTLE S.A., Vevey (CH)

(72) Inventor: NICOLAS OBLIGER, Franey (FR)

(21) Appl. No.: 18/258,100

(22) PCT Filed: Dec. 6, 2021
(86) PCT No.: PCT/EP2021/084435

§ 371 Date: Jun. 16, 2023

(30) Foreign Application Priority Data
Dec. 21, 2020 (EP) 20215967.9

(51) Int. Cl. A47J 31/36

(52) U.S. Cl. CPC A47J 31/3657

(57) ABSTRACT

The invention concerns a beverage portion dispensing system of: —a casing (6) holding a flexible portioning band (3) containing a plurality of individually sealed beverage precursor portions (2), and —a beverage portion dispenser (1) for storing the flexible portioning band and separating the beverage precursor portions from the band, said beverage portion dispenser comprising: a receiving area (11) for receiving and positioning the casing (6), a band drive assembly (12) arranged for taking the band out of the upper opening of the casing, a separating assembly (13) configured to individually separate each portion from the band at the separating position, wherein: —each of the lateral walls (62, 63) of the casing comprises at least one projection (621, 631) rising from the surface of said wall and extending at least partially between the rear wall and the front wall, and —the receiving area (11) comprises at least two retaining means (11a, 11b), each of said retaining means being configured to cooperate with one projection rising from the surface of one lateral wall of the casing.

### FIELD OF THE INVENTION

The present invention relates to an apparatus for dispensing individual portions of beverage precursor stored as a packaging band and adapted to the preparation of beverages in a beverage preparation device.

### BACKGROUND OF THE INVENTION

Document WO2019/219523 discloses a beverage portion dispenser for receiving a portioning band containing a plurality of individually sealed beverage precursor portions for the preparation of a beverage wherein the dispenser comprises means for individually collecting and dispensing the beverage precursor portions to a dispensing area, wherein the collecting and dispensing means comprises a portion drive assembly arranged for receiving a part of the flexible portioning band and a separating assembly for individually separating the beverage precursor portions from the portioning band. The portioning band is initially arranged in a casing, and is progressively withdrawn from it.

With this dispenser, it has been observed that, while the portioning band is being progressively withdrawn, the force exerted on the band by the portion drive assembly induces a movement of the casing itself, which is pulled up with the band with the risk that the band may not be well positioned in the drive assembly and that jam occurs inside the dispenser.

### SUMMARY OF THE INVENTION

An object of the invention is to address the above existing problem.

In a first aspect of the invention, there is provided a system of:
a casing holding a flexible portioning band containing a plurality of individually sealed beverage precursor portions, said casing comprising:
   a top wall and two lateral walls extending vertically from the top wall to a bottom wall and horizontally between a rear wall and a front wall, and
   said top wall comprising an upper opening, and
a beverage portion dispenser for storing the flexible portioning band and separating the beverage precursor portions from the band, said beverage portion dispenser comprising:
   a receiving area for receiving and positioning the casing, the casing being positioned inside the receiving area so that the top wall faces upwards,
   a band drive assembly arranged for taking the band out of the upper opening of the casing and for moving successively each sealed beverage precursor portion to a separating position,
   a separating assembly configured to individually separate each portion from the band at the separating position,
      wherein:
each of the lateral walls of the casing comprises at least one projection rising from the surface of the wall and extending at least partially between the rear wall and the front wall, and
the receiving area comprises at least two retaining means, each of said retaining means being configured to cooperate with one projection rising from the surface of one lateral wall of the casing.

The system comprises a casing that holds beverage portions and a dispenser that holds said casing and that dispenses beverage portions.

The casing holds a flexible portioning band, which contains a plurality of individually sealed beverage precursor portions. This casing comprises a top wall and two lateral walls that extend vertically from the top wall to a bottom wall and horizontally between a rear wall and a front wall. Preferably, the casing presents the shape of a parallepiped.

The top wall of the casing comprises an upper openable opening. Once this opening is opened, the flexible portioning band can be pulled out therefrom.
The beverage precursor enables the preparation of a beverage in a beverage preparation device further to mixing with a liquid.

The casing is self-standing, preferably rigid or semi-rigid protective casing. It provides a compact storage without the portioning band being directly manipulated so reducing the risk of damaging the beverage precursor portions. The casing can be made of compostable material, in particular one or a combination of cardboard, paper, cellulose, cellophane, PLA.

The portioning band comprising a pair of packaging sheets sealed to one another for enclosing and sealing the portions individually and separately in a substantially oxygen impervious manner by the sheets being sealed together about each portion. The beverage precursor portions take the form of substantially spherical shapes which are covered on each side of the portioning band by a sheet being formed with cavities to receive each portion and wherein at least one of the sheets can be cut or torn at least partially about each portion for removal of each portion individually.

Preferably, the band comprises a free part of the sheets between the neighboring beverage precursor portions such that the band can be arranged in continuous manner in superimposed or wound layers with the portions being arranged in quincunx between two adjacent layers.

The portioning band may preferably be arranged in a continuous manner in superimposed layers within the casing.

The beverage portion dispenser is arranged to store the flexible portioning band and to separate the beverage precursor portions from the band.

This dispenser comprises a receiving area for receiving and positioning the casing. The casing is positioned inside this receiving area so that its top wall faces upwards.

The dispenser comprises a band drive assembly arranged for taking the band out of the upper opening of the casing and for moving successively each sealed beverage precursor portion to a separating position.

The band drive assembly may comprise a driving member comprising portion receiving cavities shaped for individually catching a number of portions and for moving the respective part of the band containing the caught portions to the separating assembly. For example, the receiving cavity may have a circular opening which matches the cross-section of the beverage precursor portions which may be compacted and of substantially spherical shape. The number of portions that may be caught by the portion drive assembly to ensure a balance between a gentle but reliable drive of the system is preferably between 2 and 5, more preferably 3 or 4 beverage precursor portions.

In the preferred form, the drive member comprises a driving wheel with a cylindrical wall provided with portion receiving cavities spaced apart at its circumference and a motor for driving the cylindrical wall in rotation along an axis transversal to the driving direction of the portioning band. The driving member is arranged with control means to move the driving wheel incrementally or step-wisely of one step at a time to position one receiving cavity containing a beverage precursor portion next to the separating assembly.

The driving wheel preferably comprises positioning members arranged incrementally on the driving wheel to cooperate with at least one position sensor. Therefore, the driving wheel can be advanced from one increment at a time and this increment is determined by the position sensor. The position sensor can be mechanical, optical and or electromagnetic. The positioning members could also be omitted and the beverage precursor portions could be sensed by the position sensor instead. The driving wheel may be driven by a motor coupled to the driving wheel by a transmission system, for example a combination of a geared wheel and endless screw. The driving wheel can be dimensioned as a function of the arrangement of the portions in the portioning band and especially in relation to the distance between the centers of the neighboring portions, the diameter of the portions and the number of portions to be received by the cavities when the band is pulled by the portion drive assembly.

The dispenser comprises a separating assembly configured to individually separate each portion from the band at the separating position,

The separating assembly may comprise a cutting tool for opening the portioning band at the location of each individual beverage precursor portion. The cutting tool comprises a cutter arranged for cutting at least one cutting line in the band preferably around the beverage precursor portion. In particular, the cutter may be arranged for cutting the band at a cutting line which is preferably located at the intersection between the beverage precursor portion and a sealed part of the band. The sealed part may be formed by the sealing of two packaging sheets. By cutting at the intersection, the cutter does not damage the portion as it might be brittle and would break easily into smaller pieces.

The separating assembly may comprise an extracting member arranged for engaging against the beverage precursor portion after the band has been cut by the cutting tool. The extracting member assists the removal of the beverage precursor portions by ensures that the portions are properly detached from the band as they may adhere by vacuum and/or mechanical or material sticking effect in the thermoformed receiving cavities.

The extracting member may be formed as a stationary protruding surface positioned angularly after the cutting tool and inside the driving wheel so that when the wheel is driven in rotation and a receiving cavity filled with a portion comes in radial alignment with the extracting member, the beverage precursor portion abuts against the protruding surface and is forced outside the cavity of the driving wheel.

The apparatus may further comprise detecting and/or identifying member arranged for detecting and/or identifying at least one detection and/or identification element associated to the beverage precursor portion(s). For example, the detecting and/or identifying member is an optical reader and the detection and/or identification element is an optical element, such as a barcode, glyph or design, which is positioned on the portioning band. Preferably, an optical element is placed between two neighboring beverage precursor portions. The detection or identification element may provide information to the apparatus such as: the type of beverage precursor portions, the number of portions on the band, the counting of the beverage precursor portions on the band and any combinations thereof.

In the casing, each lateral wall comprises at least one projection rising from the surface of the lateral wall and this projection extends at least partially between the rear wall and the front wall.

In addition, the receiving area of the dispenser is provided with at least two retaining means, each of said retaining means being configured to cooperate with one of the projection rising from the surface of one of the lateral wall of the casing.

Consequently, the cooperation between the projections provided on each lateral side of the casing and the retaining means that are part of the fixed receiving area prevents upwards movement of the casing when the flexible portioning band is pulled out of the casing and engaged with the band drive assembly.

Preferably, for each of the lateral walls of the casing, the at least one projection extends from the rear wall to the front wall.

Preferably, each projection of one lateral wall is symmetrical to one projection of the other lateral wall in view of the longitudinal plane of the casing. By longitudinal plane, it is meant the median plane extending between the rear and the front walls of the casing.

According to one preferred embodiment, for each of the lateral walls of the casing, one projection is at the bottom of said lateral wall.

In one embodiment, each of the lateral walls of the casing comprises one projection only and this projection is at the bottom.

In another embodiment, each of the lateral walls of the casing comprises two projections, the first projection being at the bottom of the wall and the second projection being at the top of the wall.

In these two embodiments, preferably, for each of the lateral walls of the casing, the projection is at the interconnexion of the bottom of the lateral wall and of the lateral side of the bottom wall and at the interconnexion of the top of the lateral wall and of the lateral side of the top wall.

Even more preferably, each projection is a flange formed by the edges of the lateral wall and the bottom wall or the lateral wall and the top wall.

Preferably, the receiving area comprises at least two lateral receiving walls, said lateral receiving walls defining an area for positioning the casing, and the retaining means of the receiving area are grooves in said two lateral walls.

Consequently, the projections rising from the surface of the casing lateral walls and extending between the rear wall and the front wall are able to slide inside said grooves with the results of strongly holding the casing inside receiving area even if an upwards force is exerted on the casing during the movement of the flexible band out of the opening.

In the present application the terms “internal”, “external”, “rear”, “front”, “top”, “bottom” and “lateral” are used to describe the relational positioning of features of the invention. These terms should be understood to refer to the casing and the receiving area in their normal orientation when positioned in a beverage preparation dispenser for the production of a beverage as shown in FIGS. 1 to 5.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Specific embodiments of the invention are now described further, by way of example, with reference to the following drawings in which:

FIG. 1 illustrates a beverage dispenser 100 comprising a system according to the invention,

FIG. 2 is a magnified view of a part of FIG. 1,

FIG. 3 is a vertical cross section of the system of the beverage portion dispenser and the casing,

FIG. 4 is an isolated view of the casing and the first driving wheel,

FIG. 5 illustrates the preferred manner to position the band inside the casing,

FIG. 6 is an isolated view of the casing and a part of the receiving area 11,

FIG. 7A is a magnified view of FIG. 6,

FIG. 7B is a side view of a part of FIG. 6,

FIG. 8 is a schematic illustration of a variant of FIG. 6.

### DETAILED DESCRIPTION OF EXEMPLARY EMBODIMENTS

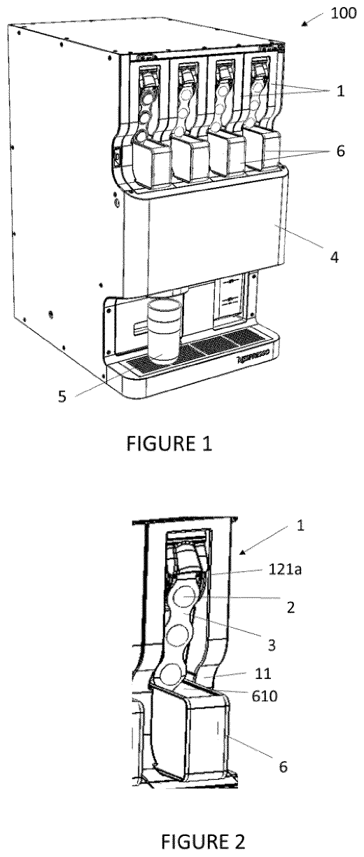

FIG. 1 illustrates a beverage dispenser 100 enabling the dispensing of a beverage in a drinking cup 5. The beverage dispenser comprises a beverage preparation unit 4 configured to prepare a beverage from a beverage precursor portion.

The beverage dispenser comprises several beverage precursor portion dispensers 1, each of them being configured to dispense a beverage precursor portion from a casing 6 holding said beverage precursor portions.

The different beverage precursor portion dispensers 1 can hold different types of precursors, like infusible precursor like roast and ground coffee or different types of roast and ground coffee differing by their origins or treatments (decaffeinated), or soluble precursor like soluble coffee, milk powder, chocolate powder. Some or all of the dispensers 1 can also dispense the same precursors.

The beverage preparation unit 4 comprises at least one device for contacting the beverage precursor portion with a diluent. Different types of devices can be implemented alone or in combination such as: a jet(s) head, a mixing bowl, a whipper bowl, a brewing chamber. The mixing bowl can be a chamber configured to receive the diluent and at least one soluble beverage precursor. It can be designed so as to make an efficient contact of the precursor and the diluent and improve the dissolution of the soluble precursor.

The jet(s) head can be a nozzle delivering at least one jet of diluent in the mixing bowl.

The whipper bowl usually comprises a first part which is a mixing chamber configured to receive the diluent and the soluble precursor and a second part comprising a whipper configured to make the mixture of the diluent and the precursor foam.

The brewing chamber can be a chamber configured to receive an infusable beverage precursor and water. In the brewing process, heated water infuses and extracts flavours from the infusable precursor. The brewing chamber can contain a filter to allow beverage to drain from the infused precursor and water mixture It can be configured to be hermetically closed to receive and hold the diluent under pressure and to retain the infusable precursor.

The beverage preparation unit 4 can comprise several devices for contacting the beverage precursor portion with a diluent, these several devices can be either identical or different.

In another embodiment, the dispenser 1 can be a food dispenser comprising a food beverage preparation unit in place the beverage preparation unit 4.

FIG. 2 is a magnified view of FIG. 1 showing one of the beverage precursor portion dispenser 1 and its corresponding casing 6.

The casing holds a flexible portioning band 3 containing a plurality of individually sealed beverage precursor portions 2, such as the band described in WO 2019/219523 and WO 2019/219524. The casing 6 comprises a top opening 610 from which the band can be pulled out and driven by a driving wheel 121a of the beverage precursor portion dispenser.

Accordingly, the beverage precursor portion dispenser 1 stores the flexible portioning band 3 inside its casing 6 within a receiving area 11 of the beverage precursor portion dispenser. This receiving area 11 enables the correct positioning of the casing for the operation of pulling the band 3 out of the casing.

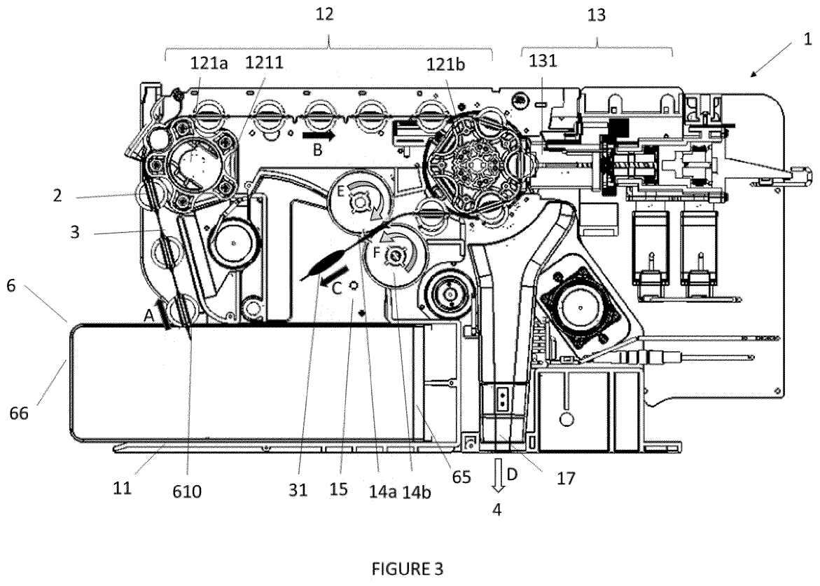

FIG. 3 illustrates the movement of the band 3 inside the dispenser.

The casing 6 has been received and is hold inside the receiving area 11 of the dispenser. The casing 6 has been oriented inside the receiving area with the rear wall 65 at the rear inside of the receiving area whereas the front wall remains partly outside the receiving area 11.

The dispenser 1 comprises a band drive assembly 12, a separating assembly 13 and a collecting chamber 15.

The band drive assembly 12 is arranged to pull the band 2 out of the casing and to supply it to the separating assembly 13. The band drive assembly 12 comprises a first driving wheel 121a arranged for taking the band 2 out of the casing 6 and a second driving wheel 121b for positioning the band in the separating position, both wheels moving successively each sealed beverage precursor portion from the casing to the separating assembly 13 and then to the collecting chamber 15. The arrows A, B, C illustrate the movement of the band 2 in the dispenser.

Each driving wheel or drum 121a, 121b is provided with a plurality of portion receiving cavities 1211 arranged in circumferential alignment formed in the outer annular surface of the driving wheel or drum. The wheels are driven in rotation in a stepwise fashion by corresponding driving members. Each wheel is mounted around an axle of transversal axis. The receiving cavities 1211 are individually dimensioned and arranged at distance one another so as to match with the distance between the neighboring beverage portions of the band. As the portions are captured by the receiving cavities 1211 moving step-wisely, the portioning band 3 is progressively withdrawn from the casing 6 and moved to the separating assembly 13 and then to the collecting chamber 15.

The separating assembly 13 is configured to individually separate each beverage precursor portion 3 from the band 2. The separating assembly essentially comprises a cutting tool 131. The cutting tool is arranged for at least partially cutting an opening in the band 2 about the forefront sealed portion 3a present in the portion drive assembly.

The dispenser comprises a portion collecting means 17, such as a chute and the like, arranged for gently receiving and transporting by gravity or otherwise (e.g. air pressure), the beverage portion 2 to a beverage preparation unit 4 as illustrated by the downwardly oriented arrow D.

The second driving wheel 121b is arranged to drive and introduce the first end of the band 2 between the surfaces of the two rollers 141a, 141b rotating in opposite directions with the result that the band is pulled by the two rollers and introduce in a downstream collecting chamber 15. The collecting chamber 15 is configured to store the band from which the beverage precursor portions are separated and that is compressed.

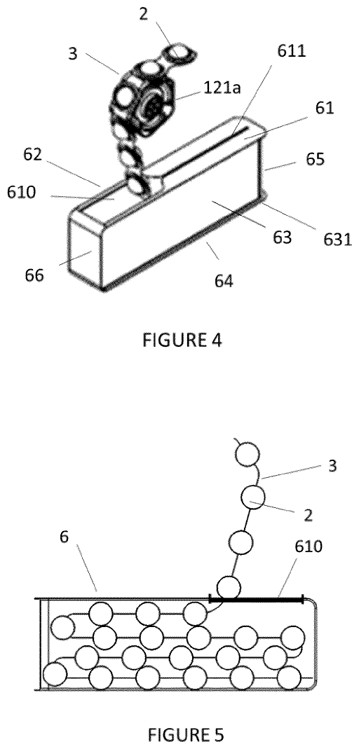

FIG. 4 is an isolated view of the casing and the flexible portioning band 3 held and pulled by the first driving wheel 121a of the beverage portion dispenser.

The casing presents a globally parallepipedic shape with a bottom wall 64 through which extends two lateral walls 62, 63, a rear wall 65 and a front wall 66. The top comprises a top wall 61 comprising the upper opening 610. Before introducing the casing 6 in the dispenser, the opening 610 is usually closed by a removable cover. This removable cover can be removed manually or automatically during the introduction of the casing inside the dispenser. When this casing is fully introduced and positioned inside the receiving area 11 of the beverage precursor portion dispenser, the wheel 121a is positioned above the top opening 610 of the casing as illustrated in FIG. 3. It is important that the wheel 121a holds and retains firmly the flexible portioning band 3 and that this band does not slide back during its movement through the beverage precursor portion dispenser. The force exerted by the wheel must be sufficient to pull the band 3 and must prevent any force of return that would damper the movement of the band. Since the movement of the band 3 is sequenced due to the successive positioning of the different precursor portions on the surface of the driving wheels 121a, 121b and in the separating assembly 13, the force exerted by the wheel 121a is relatively strong and can lead to an upwards movement of the whole casing 6 present inside the receiving area 11 which is not desired the casing 6 may become blocked inside the beverage precursor portion dispenser and the band 3 may become twisted and may not be correctly oriented to the wheel 121a.

This problem may all the more rise when the band 3 scraps on the edges of the opening 610 of the casing. This problem of scraping increases with a casing designed for presenting the smallest volume as possible. Indeed it is usually preferred to design the casing as small as possible. First because the size of the casing directly impacts the size of the receiving area and of the dispenser. Secondly, smaller casings are preferred in terms of storage and supply of said casing between the place of manufacturing, the delivery (such as trucks) and the customer premises. In order to store as many as possible beverage precursor portions inside small casings, the portions are more compacted inside the casing. In particular the width of the casing is preferably very close to the width of the band to optimise the number of portions inside the casing. FIGS. 4 and 5 illustrate the preferred manner to position the band inside the casing and make clear that the edge of the band can scrap the edge of the opening 610 of the casing. It can be underlined that the width of this opening 610 is limited by the zone of sealing of the walls of the casing. To provide a casing that is tight and protective and with sealing zones that are not tearable, the opening shall impinge on this sealing zone and the width of the aperture must be defined as close as possible to the width of the band.

In addition, the problem of movement of the casing under the force exerted by the band 2 is emphasised when the casing 6 is made at least partly of a light material such as:
a paper-based structure material such as PBS, PLA, cellulose and combinations thereof.
a laminated paper. The laminate may comprise a seal layer such as PLA, PBA, PBS, copolyester of adipidic acid, 1, 4-butanediol and dimethyl terephthalate (PBAT), polylactic acid (PLA), polyvinyl butyral (PVB), poly(vinyl acetate-ethylene) (VAE), poly(ethylene-vinyl acetate) (EVA) and combinations thereof. It may comprise an oxygen barrier layer such as EVOH, PVOH, SiOx, cellophane, metal and combinations thereof. An example of laminate can be PLA/EVOH/PLA. In these examples, PLA may be replaced by PBA, PBS, PPS, copolyester of adipidic acid, 1, 4-butanediol and dimethyl terephthalate (PBAT), polyvinyl butyral (PVB), poly(vinyl acetate-ethylene) (VAE), poly(ethylene-vinyl acetate) (EVA) and combinations thereof. EVOH may also be replaced by PVOH and/or SiOx.

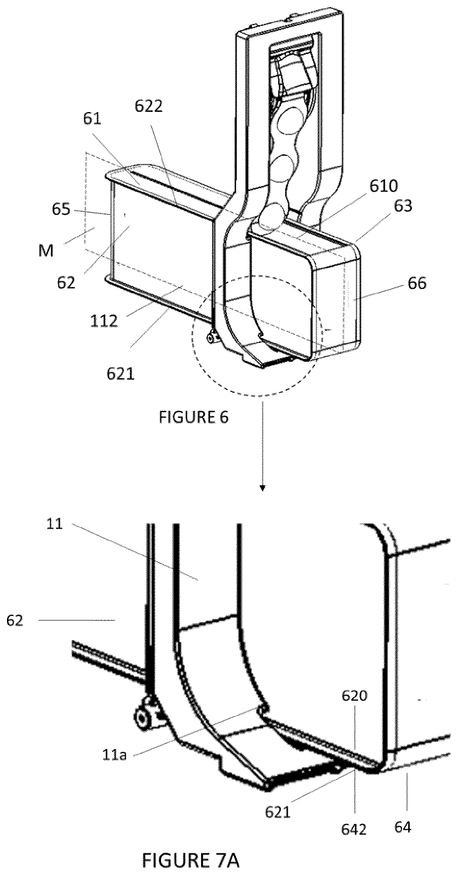

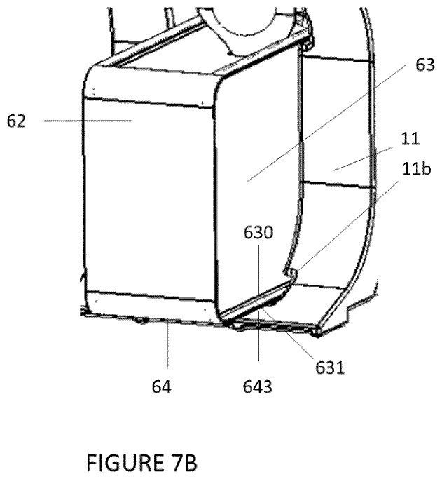

In order to prevent such a movement of the casing 6 in the receiving area 11, the first lateral wall 62 of the casing comprises a projection 621 rising from the surface of this wall and extending between the rear wall 65 and the front wall 66 as illustrated in FIG. 6. Similarly a projection 631 rises from the surface of the second lateral wall 63 of the casing as illustrated in FIG. 7B.

In addition, the receiving area 11 comprises a first retaining means 11a, in the form of a groove and configured to cooperate with the projection 621 as illustrated in FIG. 7A. Similarly, the receiving area 11 comprises a second retaining means in the form of a groove 11b and configured to cooperate with the projection 631 of the casing as illustrated in FIG. 7B. These retaining means 11a, 11b prevent the movement of the casing 6 when the band 3 is pulled upwardly.

The projections 631, 621 are preferably at the bottom of the lateral walls 63, 62 respectively in order to cooperate with retaining means 11a, 11b that would not create obstruction near the aperture 610 at the top wall of the casing, which would potentially damper the movement of the band 3.

When the casing is made of a material that is deformable, such as a light material, again it is preferred that the projections 631, 621 are at the bottom of the lateral walls 63, 62 because projections rising from the middle of the lateral walls may escape from the retaining means of the receiving area due to the deformation of the material of the lateral walls under the exertion of an upwards force.

Preferably the projections 612, 631 are symmetric in view of the longitudinal median plane M of the casing as illustrated in FIG. 6.

In the preferred illustrated embodiment, each projection is at the interconnexion of the bottom, 620 respectively 630, of one lateral wall and of one lateral side, 642 respectively 643, of the bottom wall.

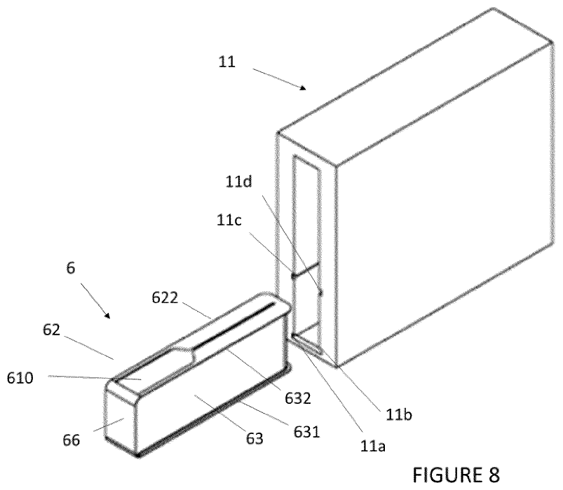

FIG. 8 illustrates a variant where the casing 6, similar to the one illustrated in FIG. 6, comprises:
two projections 621, 622 rising from the surface of the first lateral wall 62 of the casing at the bottom and the top of said wall respectively, and
two projections 631, 632 rising from the surface of the second lateral wall 63 of the casing at the bottom and the top of said wall respectively.

The receiving areas 11 comprises four retaining means, in the form of grooves, each retaining means 11a, 11b, 11c, 11d cooperating with one dedicated projection 621, 631, 622, 632 respectively. Consequently, the casing is retained through its bottom and top projections; this embodiment can be implemented of the top retaining means 11c, 11d do not impinge on the opening 610. In a particular embodiment, the top projections 622, 632 can be made larger to avoid this impingement on the opening surface while providing sufficient material for the projections of be retained in the retaining means 11c, 11d.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

beverage precursor portion dispenser 1
receiving area 11
   retaining means 11a, 11b, 11c, 11d
   top wall 111
   lateral walls 112, 113
band drive assembly 12
   driving wheel 121
separating assembly 13
   cutter 131
storing chamber 15
dispensing duct 17

beverage precursor portions 2

flexible portioning band 3

beverage preparation unit 4

cup 5

casing 6
top wall 61
   opening 610
   slit 611
lateral walls 62, 63
   projection 621, 631, 622, 632
   bottom edge 620, 630
bottom wall 64
lateral edge 642, 643
rear wall 65
front wall 66

beverage dispenser 100

1. Beverage portion dispensing system comprising:
a casing holding a flexible portioning band, said band containing a plurality of individually sealed beverage precursor portions, said casing comprising:
a top wall and two lateral walls extending vertically from the top wall to a bottom wall and horizontally between a rear wall and a front wall, and
said top wall comprising an upper opening,
and
a beverage portion dispenser for storing the flexible portioning band and separating the beverage precursor portions from the band, said beverage portion dispenser comprising:
a receiving area for receiving and positioning the casing, the casing being positioned inside the receiving area so that the top wall faces upwards,
a band drive assembly arranged for taking the band out of the upper opening of the casing and for moving successively each sealed beverage precursor portion to a separating position,
a separating assembly configured to individually separate each portion from the band at the separating position,
wherein:
each of the lateral walls of the casing comprises at least one projection rising from the surface of said wall and extending at least partially between the rear wall and the front wall, and
the receiving area comprises at least two retaining means members, each of said retaining means member being configured to cooperate with one projection rising from the surface of one lateral wall of the casing.

2. System according to claim 1, wherein for each of the lateral walls the at least one projection extends from the rear wall to the front wall.

3. System according to claim 1, each projection of one lateral wall is symmetrical to one projection of the other lateral wall in view of the longitudinal plane of the casing.

4. System according to claim 1, wherein for each of the lateral walls of the casing, one projection is at the bottom of said lateral wall.

5. System according to claim 4, wherein for each of the lateral walls of the casing, the bottom projection is at the interconnection of the bottom of the lateral wall and of the lateral side of the bottom wall.

6. System according to claim 4, wherein the projection is a flange formed by the edges of the lateral wall and the bottom wall.

7. System according to claim 4, wherein each of the lateral walls of the casing comprises two projections, the first projection being at the bottom of the wall and the second projection being at the top of the wall.

8. System according to claim 4, for each of the lateral walls of the casing, the top projection is at the interconnection of the top of the lateral wall and of the lateral side of the top wall.

9. System according to claim 8, wherein the projection is a flange formed by the edges of the lateral wall and the top wall.

10. System according to claim 1 wherein the receiving area comprises at least two lateral receiving walls, said lateral receiving walls defining an area for positioning the casing, and the retaining member of the receiving area are grooves in said two lateral walls.

11. Beverage portion dispensing system comprising:
a casing holding a flexible portioning band, said band containing a plurality of individually sealed beverage precursor portions, said casing comprising:
a top wall and two lateral walls extending vertically from the top wall to a bottom wall and horizontally between a rear wall and a front wall, and
said top wall comprising an upper opening,
and
a beverage portion dispenser for storing the flexible portioning band and separating the beverage precursor portions from the band, said beverage portion dispenser comprising:
a receiving area for receiving and positioning the casing, the casing being positioned inside the receiving area so that the top wall faces upwards,
a band drive assembly arranged for taking the band out of the upper opening of the casing and for moving successively each sealed beverage precursor portion to a separating position,
a separating assembly configured to individually separate each portion from the band at the separating position,
wherein:
each of the lateral walls of the casing comprises at least one projection rising from the surface of said wall and extending at least partially between the rear wall and the front wall, and
the receiving area comprises at least two retaining members, each of said retaining member being configured to cooperate with one projection rising from the surface of one lateral wall of the casing, and holding a flexible portioning band, said band containing a plurality of individually sealed beverage precursor portions, said casing comprising:
a top wall and two lateral walls extending vertically from the top wall to a bottom wall and horizontally between a rear wall and a front wall, and
said top wall comprising an upper opening,
and wherein each of the lateral walls of the casing comprises at least one projection rising from the surface of said wall and extending at least partially between the rear wall and the front wall.
